(19) United States
(12) Patent Application Publication
(10) Pub. No.: US 2003/0177249 A1
(43) Pub. Date: Sep. 18, 2003

(54) System and method for limiting unauthorized access to a network

(75) Inventors: Hitoshi Takanashi, Fremont, CA (US); Isao Iwasa, Los Altos, CA (US)

Correspondence Address: SQUIRE, SANDERS & DEMPSEY L.L.P, 600 HANSEN WAY, PALO ALTO, CA, 94304-1043, US

(73) Assignee: NTT Multimedia Communications Laboratories, Palo Alto, CA

(21) Appl. No.: 10/278,614

(22) Filed: Oct. 22, 2002

Related U.S. Application Data
(60) Provisional application No. 60/364,815, filed on Mar. 15, 2002.

(51) Int. Cl. G06F 15/16

(52) U.S. Cl. 709/229

(57) ABSTRACT

A system for limiting unauthorized access to a network comprises an IP assignment system and an access system. The IP assignment system includes a random number generator capable to generate a random number between a minimum and maximum leasing time; and an IP assignment engine, communicatively coupled to the generator, capable to receive, from a client, a request for an IP address, assign an IP address to the client, randomly determine, using the generator, a leasing time for the IP address, and send, to the client, a packet that includes the IP address and leasing time. The access system includes a packet monitoring engine capable to receive a packet sent to a client, the packet including an IP address, a random leasing time and a renewal window; and an access engine, communicatively coupled to the packet monitoring engine, capable to enable the client to access a network and terminate access to the network if a renewal packet is not received during the renewal window.

### PRIORITY REFERENCE TO PRIOR APPLICATION

This application claims benefit of and incorporates by reference patent application Ser. No. 60/364,815, entitled “Random DHCP Renewal Time Interval,” filed on Mar. 15, 2002, by inventors Hitoshi Takanashi and Isao Iwasa.

### TECHNICAL FIELD

This invention relates generally to dynamic IP address assignment, and more particularly, but not exclusively, provides a system and method for limiting unauthorized access to a network by assigning a random DHCP renewal time window to a wireless client.

### BACKGROUND

In a wireless environment, wireless clients generally do not have fixed IP addresses due to their temporary presence in the environment. Conventionally, to get a temporary IP address via dynamic IP address assignment, a wireless client first must broadcast a Dynamic Host Configuration Protocol (DHCP) request. A DHCP server hears the request and then assigns the client an IP address for a fixed leasing time. An access control server (ACS) then requests a user's ID and password from the wireless client so as to enable the client to login to a network behind the ACS. The ACS then confirms the validity of the combination of the user's ID and password by comparing the user's ID and password with user data stored in a database in the ACS or other server, such as a RADIUS server. After confirmation, the ACS opens its gates to the wireless client so that the user of the wireless client can access the network.

To prevent unauthorized access to the network, only packets having the wireless client's dynamically assigned IP address and its MAC address are allowed to pass through the ACS to the network. However, there are many tools available that enable a hacker to sniff wireless channels to get a wireless client's MAC and IP addresses from packets. The hacker can then impersonate the wireless client by using the addresses and then access the network after the wireless client logs off.

In addition, a hacker can extend his or her unauthorized access by renewing his access at regular intervals. Renewing is done by sending renewal packets during known renewal windows. Accordingly, the hacker can stay logged onto the network indefinitely by sending renewal requests to the DHCP server during the known fixed renewal windows.

### SUMMARY

The present invention provides a system for limiting unauthorized access to a network by assigning a random DHCP time renewal window (also referred to as an interval) to a wired or wireless client. The system comprises an access control server (ACS), DHCP server, and a user database. The DHCP server is coupled to a network, such as the Internet or corporate intranet, and to access points for wired or wireless clients to log into. The DHCP server and user database are behind the ACS.

The DHCP server includes an IP assignment system that, in response to a DHCP broadcast from a client, assigns an IP address to the client (conveyed to the wireless client via a DHCP reply packet). In addition, the IP assignment system also assigns a leasing time and renewal window for the IP address that is also conveyed to the client in the DHCP reply packet. The leasing time and/or renewal window can be set randomly in contrast to a conventional system in which the leasing time is fixed and the renewal window is at the midpoint of the leasing time. If the client does not send a renewal request to the DHCP server during the renewal window, the IP assignment system will cancel the IP address assignment and make it available for assignment to another client.

The ACS includes an access system that listens for a DHCP reply packet conveying an assigned IP address, leasing time, and renewal window to a client. Upon finding a DHCP reply packet, the access system starts a timer and listens for a renewal packet from the client during the renewal window specified in DHCP reply packet. If no renewal packet is sent to the DHCP server, then the access system terminates access to the network either at the end of the renewal window or at the end of the lease time. As a hacker is unlikely to snoop the initial DHCP reply packet, the hacker is unlikely to know when the renewal window is (and therefore when to send a renewal request) since the renewal window is at a random time in contrast to conventional systems in which the renewal time is at the midpoint of a fixed lease time. Accordingly, a hacker's access time is limited to the time of the attack to the expiration of the IP address (either at the end of the renewal window or at the end of the leasing time).

The present invention further provides a method for limiting unauthorized access to a network. The method, executed in part by the IP assignment system and in part by the access system, comprises, as executed by the IP assignment system: receiving a request for an IP address from a wired or wireless client; determining an IP address to assign; randomly determining a leasing time and/or renewal window; and transmitting the IP address, leasing time, and renewal window to the client in a DHCP reply packet. The method further comprises, as executed by the access system: receiving the DHCP reply packet; starting a timer; listening for a renewal packet during the renewal window; and terminating access to a network if no renewal packet is received during the renewal window. If a renewal packet is received during the renewal window, then the starting, listening and subsequent steps are repeated.

Accordingly, the system and method advantageously limit unauthorized access to a network.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the present invention;

FIG. 2 is a block diagram illustrating an example computer for use with an embodiment of the invention;

FIG. 3 is a block diagram illustrating an IP assignment system of a DHCP server;

FIG. 4 is a block diagram illustrating an access system of an ACS;

FIG. 5A is a diagram illustrating leasing time of an IP address when no renewal packet is sent;

FIG. 5B is a diagram illustrating leasing time of an IP address when a renewal packet is sent;

FIG. 6 is a flowchart illustrating a method of assigning an IP address with a random leasing time and/or renewal time; and

FIG. 7 is a flowchart illustrating a method of terminating access to a network based on the random leasing time and/or renewal time.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

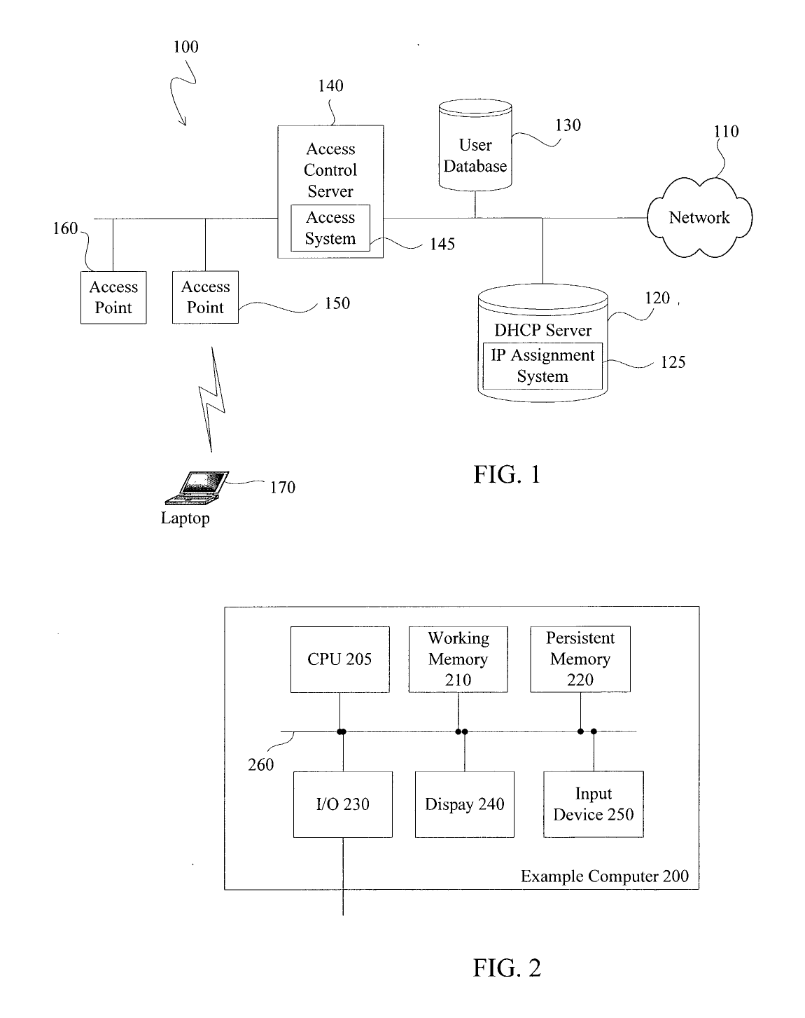

FIG. 1 is a block diagram illustrating a network system 100. in accordance with an embodiment of the present invention. Network system 100 comprises an access control server (ACS) 140, which includes an access system 145; a user database 130; a DHCP server 120, which includes an IP assignment system 125; a network 110, such as the Internet, corporate intranet, or ethernet; and access points 150 and 160, which can be communicatively coupled to a computing device, such as laptop 170, via wired or wireless techniques. Network 110, user database 130 and DHCP server 120 are all located behind ACS 140 and all can communicate with each other as well as with computing devices coupled to access points 150 and 160. In an embodiment of the invention, DHCP server 120 is not located behind ACS 140. Further, in an embodiment of the invention, there are either more or less access points than the two access points 150 and 160 in network system 100. In another embodiment of the invention, the user database 130, DHCP server 120 and/or ACS 140 can be combined into a single device.

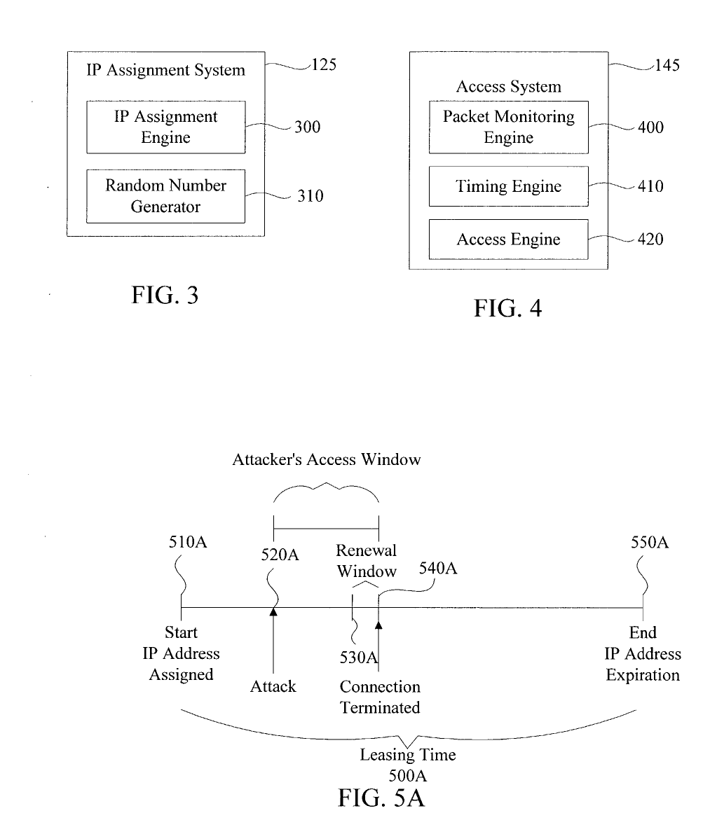

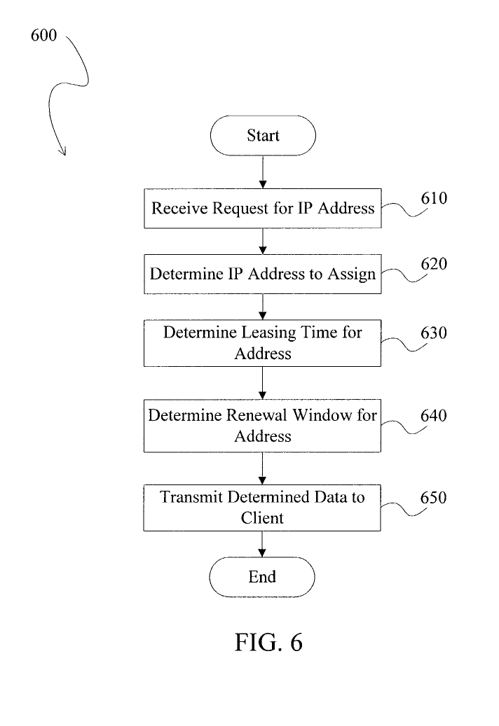

IP assignment system 125 receives a DHCP broadcast from a client (wired or wireless) requesting an IP address. In response, system 125 assigns an IP address and randomly assigns a leasing time and/or renewal window (including random window length and/or random start window start time with a fixed interval). The system 125 then forwards the IP address, leasing time, and renewal window data to the client in a DHCP reply packet. IP assignment system 125 will be discussed in further detail in conjunction with FIG. 3 and FIG. 6 below.

Access system 145 enables a client, such as laptop 170, to access network 110 after the client is assigned an IP address and the client provides the access system 145 with a User ID and password that is judged valid per data in user database 130. In addition, access system 145 listens for a DHCP reply packet from IP assignment system 125. Upon listening to a DHCP reply packet, the access system 145 starts a timer and waits for a renewal packet from the client during the renewal window specified in the reply packet. If there is no renewal window specified in the DHCP packet, the renewal window is assumed to be at the midpoint of the leasing time. If no renewal packet is received during the renewal window, the access system 145 terminates the client's ability to access to network 110 at the end of the renewal window or at the end of the leasing time. If a renewal packet is sent during the renewal window, the leasing time will be extended and the access system 145 will repeat the above-mentioned process.

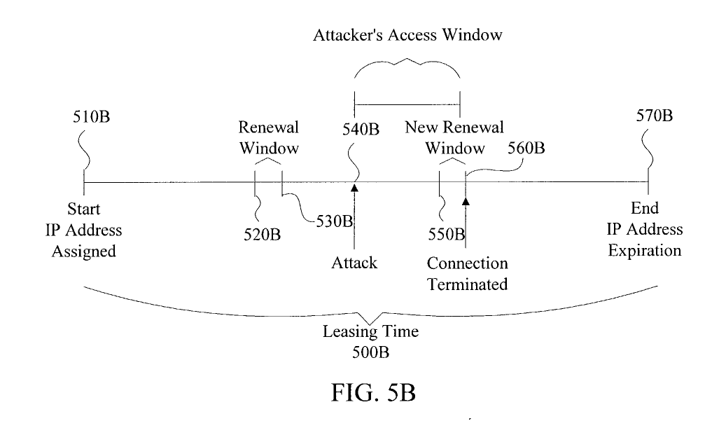

Accordingly, even if a hacker impersonates a client by snooping packets having the wireless client's IP and MAC addresses, the hacker will not know when to send a renewal packet to extend his or her access to network 110 since the renewal window is random (either at a fixed point in a random leasing time or at a random point in a random lease time or fixed lease time). Therefore, in contrast to conventional systems in which the hacker can have unlimited access to network 110, the hacker's access to the network 110 will be limited to only a portion of the initial lease time, as will be discussed in further detail in conjunction with FIG. 5A and FIG. 5B below.

FIG. 2 is a block diagram illustrating an example computer 200 for use with an embodiment of the present invention. In an embodiment of the invention, access system 145 and IP assignment system 125 may include or be resident on a computer that is substantially similar to example computer 200. The example computer 200 includes a central processing unit (CPU) 205; working memory 210; persistent memory 220; input/output (I/O) interface 230; display 240 and input device 250, all communicatively coupled to each other via system bus 260. CPU 205 may include an Intel Pentium® microprocessor, a Motorola Power PC® microprocessor, or any other processor capable to execute software stored in persistent memory 220. Working memory 210 may include random access memory (RAM) or any other type of read/write memory devices or combination of memory devices. Persistent memory 220 may include a hard drive, read only memory (ROM) or any other type of memory device or combination of memory devices that can retain data after example computer 200 is shut off. I/O interface 230 is communicatively coupled, via wired or wireless techniques, to other servers, networks, or other devices in network system 100. Display 240 may include a cathode ray tube display or other display device. Input device 250 may include a keyboard, mouse, or other device for inputting data, or a combination of devices for inputting data.

One skilled in the art will recognize that the example computer 200 may also include additional devices, such as network connections, additional memory, additional processors, LANs, input/output lines for transferring information across a hardware channel, the Internet or an intranet, etc. One skilled in the art will also recognize that the programs and data may be received by and stored in the example computer 200 in alternative ways.

FIG. 3 is a block diagram illustrating an IP assignment system 125 of DHCP server 120 (FIG. 1). IP assignment system 125 comprises an IP assignment engine 300 and a random number generator 310. In an embodiment of the invention, the random number generator 310 includes a pseudo-random number generator that generates numbers distributed between a minimum and maximum leasing time. The distribution may be based on a normal distribution; Bernoulli distribution; binomial distribution; hypergeometric distribution; noncentral hypergeometric distribution; extended hypergeometric distribution; multinomial distribution; multivariate hypergeometric distribution; multivariate noncentral hypergeometric distribution; multivariate extended hypergeometric distribution; shuffling distribution; negative exponential distribution; positive exponential distribution; Poisson distribution; Gaussian distribution; uniform distribution; or other distribution. The seed of the pseudo-random number can be a preset number or it can be the time value of the moment when the random number is generated or can be generated via other techniques.

The IP assignment engine 300 listens for a request for an IP address and assigns an IP address to the requesting client. In addition, the IP assignment engine 300, using the random number generator 310, generates a random leasing time between a minimum and maximum leasing time and/or a random renewal time window. The random renewal time window can have a fixed or random length.

FIG. 4 is a block diagram illustrating access system 145 of ACS 140. Access system 145 comprises a packet monitoring engine 400, a timing engine 410, and an access engine 420. Packet monitoring engine 400 monitors packets and listens for DHCP reply packets that in one embodiment include an assigned IP address, random leasing time and/or random renewal window time (and optionally renewal window length). In addition, the packet monitoring engine 400 listens for renewal packets from a wireless client during the renewal window specified in the DHCP reply packets.

The timing engine 410 starts timing after packet monitoring engine 400 monitors a DHCP reply packet. If a renewal packet is sent during the renewal window, timing engine 410 will restart timing.

Access engine 420 enables a client to access network 110 upon assignment of an IP address and validation of a user ID and password received from the client. In an embodiment of the invention, the access engine 420 validates the user ID and password by cross checking user ID and password data in database 130. In addition, access engine 420 terminates a terminal's access to network 110 if a renewal packet is not received during the renewal window. Termination can occur at the end of the renewal window or at the end of the leasing time. Access engine also allows IP address requests to pass through to the DHCP server 120.

FIG. 5A is a diagram illustrating leasing time 500A of an IP address when no renewal packet is sent. IP assignment engine 300, using random number generator 310, assigns a random leasing time 500A to a client. Since the leasing time is random, and therefore the renewal window is at the midpoint of the random leasing time (or the renewal window is at a random point in a fixed or random length leasing time), a hacker cannot renew the leasing time since the hacker will not know when the renewal window is and therefore when to send the renewal packet. If the wireless client does not send a renewal packet during the renewal window, which starts at point 530A and ends at point 540A, then the access engine 420 terminates access at end of the renewal window (i.e., point 540A). Accordingly, if an attacker (e.g., hacker) attacks at point 520A, his or her access window will be terminated at point 540A. In another embodiment, the attacker's access window can be terminated at the end of the leasing time (i.e., point 550A). In comparison, in a conventional system using a fixed leasing time with a fixed renewal window, it is not difficult for a hacker to determine when the renewal window occurs and therefore when to send renewal packets to extend his or her access window indefinitely.

FIG. 5B is a diagram illustrating leasing time 500B of an IP address when a renewal packet is sent. An IP address is assigned at point 510B and a renewal packet is sent during the renewal window between points 520B and 530B. An attack begins at point 540B and ends at the end of the second renewal window, at point 560B, since a second renewal packet is not sent during the second renewal window. Accordingly, an attack is limited to a small window from point 540B to point 560B instead of indefinitely as in a conventional system in which an attacker knows when to send renewal packets to extend the leasing time.

FIG. 6 is a flowchart illustrating a method 600 of assigning an IP address with a random leasing time and/or renewal time. In an embodiment of the invention, IP assignment system 125 executes method 600. IP assignment system 125 can execute several instances of method 600 for different wireless clients concurrently. First, IP assignment system 125 receives (610) a request for an IP address in the form of a DHCP broadcast from a client. The IP assignment system 125 then determines (620) an IP address to assign to the client using dynamic IP addressing. The IP assignment system 125 then determines (630) leasing time for the address. Determining (630) leasing time includes generating, with the random number generator 310, a random leasing time preferably between a preset minimum leasing time and a preset maximum leasing time. Next, the IP assignment system 125 determines (640) a renewal window during the leasing time. The renewal window can be a fixed window, such as at the midpoint of the leasing time, or can be at a random point as selected by IP assignment system 125. In addition, the length of the renewal window may be fixed or random.

In another embodiment of the invention, determining a renewal window is not required and it is assumed to be at the midpoint of the leasing time. Further, in another embodiment, IP assignment system 125 may only randomly generate the leasing time or the renewal window, but not both. After determining (640), the system 125 transmits (650) the IP address, leasing time, and leasing window to the requesting wireless client in a DHCP reply packet.

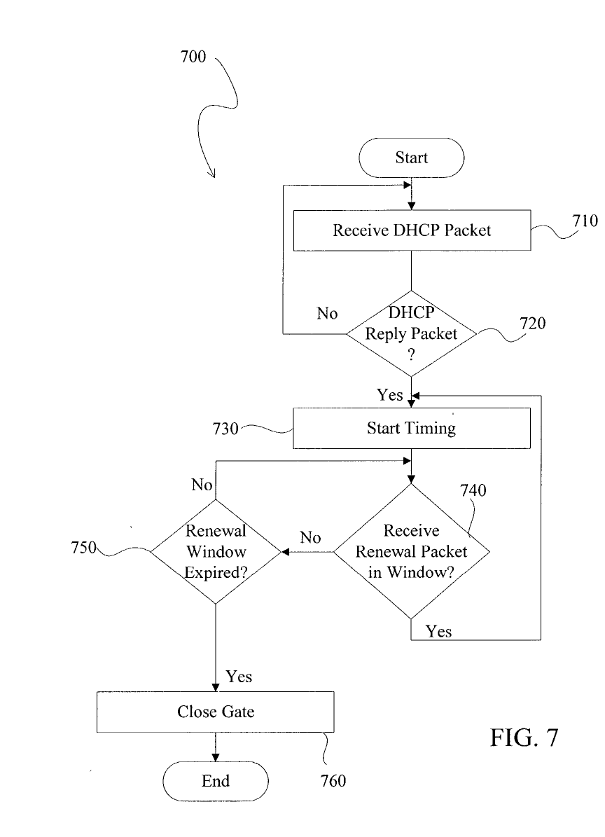

FIG. 7 is a flowchart illustrating a method 700 of terminating access to a network based on the random leasing time and/or renewal time. In an embodiment of the invention, access system 145 executes method 700. Further, access system 145 can run multiple instances of method 700 concurrently for multiple clients. After verifying a wireless client's User ID and password, the access system 145 receives (710) a DHCP packet and determines (720) if the packet is a DHCP packet. If the packet is not a DHCP packet, method 700 restarts. If the DHCP packet is a DHCP reply packet including an IP address, leasing time and optionally a renewal window, then access system 145 starts (730) timing. If no renewal window is specified, the renewal window is assumed to be at the midpoint of the leasing time.

Next, if (740) a renewal packet is received during the renewal window specified in the DHCP reply packet, then the access system starts (730) timing again in expectation of receiving another renewal packet in the next renewal window. If (740) no renewal packet is received during the renewal window, then access system 145 closes (750) the gate that enables the client to access the network 110. Closing (750) can occur at the end of the renewal window or at the end of the leasing time.

The foregoing description of the embodiments of the present invention is by way of example only, and other variations and modifications of the above-described embodiments and methods are possible in light of the foregoing teaching. For example, IP assignment system 125, access system 145 and user database 130 can be combined into a single system. Further, methods 600 and 700 can also be combined into a single method with elimination of multiple operations, such as operations 710 and 720. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving, from a client, a request for an IP address;
assigning an IP address to the client;
randomly determining a leasing time for the IP address; and
sending, to the client, the IP address and the leasing time, wherein the client must request renewal during a renewal window within the leasing time.

2. The method of claim 1, further comprising sending the renewal window to the client.

3. The method of claim 2, wherein the renewal window is of a fixed length and further comprising randomly determining a start time of the window.

4. The method of claim 2, further comprising:
enabling the client to access a network using the IP address; and
terminating access to the network if a renewal packet is not received during the renewal window.

5. The method of claim 4, wherein the terminating occurs at the end of the leasing time.

6. The method of claim 4, wherein the terminating occurs at the end of the renewal window.

7. The method of claim 4, wherein the enabling includes verifying a User ID and password.

8. The method of claim 1, wherein the client includes a wireless client.

9. The method of claim 1, wherein the client computes the renewal window using a predetermined algorithm.

10. A computer-readable medium storing instructions to cause a computer to execute a method, the method comprising:
receiving, from a client, a request for an IP address;
assigning an IP address to the client;
randomly determining a leasing time for the IP address; and
sending, to the client, the IP address and the leasing time, wherein the client must request renewal during a renewal window within the leasing time.

11. The computer-readable medium of claim 10, the method further comprising sending the renewal window to the client.

12. The computer-readable medium of claim 11, wherein the renewal window is of a fixed length and the method further comprises randomly determining a start time of the window.

13. The computer-readable medium of claim 11, the method further comprising:
enabling the client to access a network using the IP address; and
terminating access to the network if a renewal packet is not received during the renewal window.

14. The computer-readable medium of claim 13, wherein the terminating occurs at the end of the leasing time.

15. The computer-readable medium of claim 13, wherein the terminating occurs at the end of the renewal window.

16. The computer-readable medium of claim 13, wherein the enabling includes verifying a User ID and password.

17. The computer-readable medium of claim 10, wherein the client includes a wireless client.

18. The computer-readable medium of claim 10, wherein the client computes the renewal window using a predetermined algorithm.

19. A system, comprising:
means for receiving, from a client, a request for an IP address;
means for assigning an IP address to the client;
means for randomly determining a leasing time for the IP address; and
means for sending, to the client, the IP address and the leasing time,
wherein the client must request renewal during a renewal window within the leasing time.

20. A system, comprising:
a random number generator capable to generate a random number between a minimum and maximum leasing time; and
an IP assignment engine, communicatively coupled to the generator, capable to receive, from a client, a request for an IP address, assign an IP address to the client, randomly determine, using the generator, a leasing time for the IP address, and send, to the client, the IP address and leasing time,
wherein the client must request renewal during a renewal window within the leasing time.

21. The system of claim 20, wherein the IP assignment engine is further capable to send the renewal window to the client.

22. The system of claim 21, wherein the renewal window is of a fixed length and further comprising randomly determining a start time of the window.

23. The system of claim 20, wherein the client includes a wireless client.

24. The system of claim 20, wherein the client computes the renewal window using a predetermined algorithm.

25. A method, comprising:
receiving, from a client, a request for an IP address;
assigning an IP address to the client;
randomly determining a renewal window that occurs during a leasing time for the IP address; and
sending, to the client, the IP address and renewal window,
wherein the client must request renewal during the renewal window.

26. The method of claim 25, further comprising
randomly determining the leasing time and
sending the leasing time to the client.

27. The method of claim 25, wherein the leasing time is fixed.

28. The method of claim 25, further comprising:
enabling the client to access a network using the IP address; and
terminating access to the network if a renewal packet is not received during the renewal window.

29. The method of claim 28, wherein the terminating occurs at the end of the leasing time.

30. The method of claim 28, wherein the terminating occurs at the end of the renewal window.

31. The method of claim 28, wherein the enabling includes verifying a User ID and password.

32. The method of claim 25, wherein the client includes a wireless client.

33. A computer-readable medium storing instructions to cause a computer to execute a method, the method comprising:
receiving, from a client, a request for an IP address;
assigning an IP address to the client;
randomly determining a renewal window that occurs during a leasing time for the IP address; and
sending, to the client, the IP address and renewal window,
wherein the client must request renewal during the renewal window.

34. The computer-readable medium of claim 33, the method further comprising
randomly determining the leasing time and
sending the leasing time to the client.

35. The computer-readable medium of claim 33, wherein the leasing time is fixed.

36. The computer-readable medium of claim 33, the method further comprising:
enabling the client to access a network using the IP address; and
terminating access to the network if a renewal packet is not received during the renewal window.

37. The computer-readable medium of claim 36, wherein the terminating occurs at the end of the leasing time.

38. The computer-readable medium of claim 36, wherein the terminating occurs at the end of the renewal window.

39. The computer-readable medium of claim 36, wherein the enabling includes verifying a User ID and password.

40. The computer-readable medium of claim 33, wherein the client includes a wireless client.

41. A system, comprising:
means for receiving, from a client, a request for an IP address;
means for assigning an IP address to the client;
means for randomly determining a renewal window that occurs during a leasing time for the IP address; and
means for sending, to the client, the IP address and renewal window,
wherein the client must request renewal during the renewal window.

42. A system, comprising:
a random number generator capable to generate a random number between a minimum and maximum leasing time; and
an IP assignment engine, communicatively coupled to the generator, capable to receive, from a client, a request for an IP address, assign an IP address to the client, randomly determine, using the generator, a renewal window during a leasing time for the IP address, and send, to the client, the IP address and renewal window,
wherein the client must request renewal during a renewal window.

43. The system of claim 42, wherein the IP assignment engine is further capable to send the leasing time to the client.

44. The system of claim 43, wherein the renewal window is of a fixed length.

45. The system of claim 42, wherein the client includes a wireless client.

46. A method, comprising:
receiving a an IP address, a fixed leasing time, and a randomly generated start time for a renewal window during the leasing time;
enabling a client to access a network using the IP address;
terminating access to the network if a renewal packet is not received during the renewal window.

47. The method of claim 46, wherein the terminating occurs at the end of the renewal window.

48. The method of claim 46, wherein the terminating occurs at the end of the leasing time.

49. The method of claim 46, wherein the enabling includes verifying a user ID and password.

50. A computer-readable medium storing instructions for causing a computer to execute a method, the method comprising:
receiving a an IP address, a fixed leasing time, and a randomly generated start time for a renewal window during the leasing time;
enabling a client to access a network using the IP address;
terminating access to the network if a renewal packet is not received during the renewal window.

51. The computer-readable medium of claim 50, wherein the terminating occurs at the end of the renewal window.

52. The computer-readable medium of claim 50, wherein the terminating occurs at the end of the leasing time.

53. The computer-readable medium of claim 50, wherein the enabling includes verifying a user ID and password.

54. A system, comprising:
means for receiving a an IP address, a fixed leasing time, and a randomly generated start time for a renewal window during the leasing time;
means for enabling a client to access a network using the IP address;
means for terminating access to the network if a renewal packet is not received during the renewal window.

55. A system, comprising:
a packet monitoring engine capable to receive a packet sent to a client, the packet including an IP address, and a random leasing time; and
an access engine, communicatively coupled to the packet monitoring engine, capable to enable the client to access a network using the IP address and terminate access to the network if a renewal packet is not received during a renewal window within the leasing time.

56. The system of claim 55, wherein the access engine terminates access at the end of the renewal window.

57. The system of claim 55, wherein the access engine terminates access at the end of the leasing time.

58. The system of claim 55, wherein the access engine enables access via verifying a user ID and password.

59. A method, comprising:
receiving an IP address and a randomly generated leasing time;
enabling the client to access a network using the IP address;
terminating access to the network if a renewal packet is not received during a renewal window within the leasing time.

60. The method of claim 59, wherein the terminating occurs at the end of the renewal window.

61. The method of claim 59, wherein the terminating occurs at the end of the leasing time.

62. The method of claim 59, wherein the enabling includes verifying a user ID and password.

63. A computer-readable medium storing instructions for causing a computer to execute a method, the method comprising:
receiving an IP address and a randomly generated leasing time;
enabling the client to access a network using the IP address;
terminating access to the network if a renewal packet is not received during a renewal window within the leasing time.

64. The computer-readable medium of claim 63, wherein the terminating occurs at the end of the renewal window.

65. The computer-readable medium of claim 63, wherein the terminating occurs at the end of the leasing time.

66. The computer-readable medium of claim 63, wherein the enabling includes verifying a user ID and password.

67. A system, comprising:
means for receiving a packet sent to a client, the packet including an IP address and a randomly generated leasing time;
means for enabling the client to access a network using the IP address;
means for terminating access to the network if a renewal packet is not received during a renewal window within the leasing time.

68. A system, comprising:
a packet monitoring engine capable to receive a packet sent to a client, the packet including an IP address, and a randomly generated leasing time; and
an access engine, communicatively coupled to the packet monitoring engine, capable to enable the client to access a network using the IP address and terminate access to the network if a renewal packet is not received during a renewal window within the leasing time.

69. The system of claim 68, wherein the access engine terminates access at the end of the renewal window.

70. The system of claim 68, wherein the access engine terminates access at the end of the leasing time.

71. The system of claim 68, wherein the access engine enables access via verifying a user ID and password.
